(19) United States
(12) Patent Application Publication
(10) Pub. No.: US 2015/0309917 A1
(43) Pub. Date: Oct. 29, 2015

(54) Automation Framework Interface

(71) Applicant: Yongyan Wang, Portland, OR (US)

(72) Inventor: Yongyan Wang, Portland, OR (US)

(21) Appl. No.: 14/699,382

(22) Filed: Apr. 29, 2015

Related U.S. Application Data
(60) Provisional application No. 61/985,633, filed on Apr. 29, 2014.

(51) Int. Cl. G06F 11/36; G06F 3/0484

(52) U.S. Cl. CPC G06F 11/3664; G06F 11/3688; G06F 11/3692; G06F 3/04842

(57) ABSTRACT

An automation framework interface and a method for managing and operating automation software suites using the automation framework interface. The automation framework interface provides a user access to a plurality of automation suites that can be operated on an automation framework. Each of the plurality of automation suites includes a plurality of automation cases, each being an individual test case to be run on the automation framework. The automation framework interface provides a main page for selecting a specific automation suite from the plurality of automation suites, which then directs the user to an automation suite page for the specific automation suite. The automation suite page similarly allows the user to select a specific automation case from the plurality of automation cases for the specific automation suite. Through the automation framework interface the user can view operation metrics and automation logs for each of the plurality of automation cases.

The current application claims a priority to the U.S. Provisional Patent application Ser. No. 61/985,633 filed on Apr. 29, 2014.

### FIELD OF THE INVENTION

The present invention relates generally to a multi-level interface provided for interacting with a test software automation framework.

### BACKGROUND OF THE INVENTION

Test automation software is applied in numerous situations where manual testing proves time consuming, expensive, and even sub-optimal. By providing software that automates the testing process, individuals and business can save time and money while improving the effectiveness of their software testing. There are a wide variety of test automation software suites available, with different test programs being coded for specific industries and applications. Corresponding with the variety of software suites, there are a large number of user interfaces that have been designed and implemented alongside said software suites.

It is an object of the present invention to provide an automation framework interface which is compatible with a plurality of automation suites. The present invention provides multi-level design that allows users to start at a main page which allows the users to navigate to specific outputs and functions provided by the software suite. More specifically, the present invention provides a top-level interface for an automation framework as a whole. From this top-level interface, the user can then easily navigate to lower level interfaces provided for the individual automation suites that form the automation framework and subsequently to the individual automation cases that form the automation suites. Through these level-specific interfaces a user is capable of viewing test-related information as well as available commands. Ultimately, the present invention provides a complete and easy-to-navigate user interface for a automation framework.

### BRIEF DESCRIPTION OF THE DRAWINGS

FIG. 1 is a diagram for the main page of the automation framework interface.

FIG. 2 is a diagram for the automation suite page of the automation framework interface.

FIG. 3 is a diagram for the automation case page of the automation framework interface.

FIG. 4 is a flowchart depicting the process for managing and operating the plurality of automation suites on the automation framework;

FIG. 5 is a flowchart thereof, further depicting steps for displaying information on the main page;

FIG. 6 is a flowchart thereof, further depicting steps for displaying information on the automation suite page;

FIG. 7 is a flowchart thereof, further depicting steps for displaying information on the automation case page;

FIG. 8 is a flowchart thereof, further depicting steps for performing an automation operation for the plurality of automation suites;

FIG. 9 is a flowchart thereof, further depicting steps for performing an automation operation for the plurality of automation cases; and

FIG. 10 is a flowchart thereof, further depicting steps for displaying the automation framework name of the automation framework.

### DETAIL DESCRIPTIONS OF THE INVENTION

All illustrations of the drawings are for the purpose of describing selected versions of the present invention and are not intended to limit the scope of the present invention.

The present invention provides an automation framework interface 2 and a method for managing and operating automation software suites using the automation framework interface 2. The automation framework interface 2 allows a user to operate software used to interact with a plurality of automation suites 4 used to run automation tests on an automation framework 1 (computer network); each of the plurality of automation suites 4 being a unique test automation software. The automation framework interface 2 displays the plurality of automation suites 4 in a list to allow for easy selection by the user. The order of the list of the plurality of automation suites 4 can be based on pre-determined factors or may be variable according to preferences of the user.

Each of the plurality of automation suites 4 is a collection of a plurality of automation cases 5; each of the plurality of automation cases 5 being a different test case run within the automation suite. Through the automation framework interface 2, the user can readily access the plurality of automation cases 5 for each of the plurality of automation suites 4, wherein the user can view results and parameters of each of the plurality of automation cases 5. Similar to the plurality of automation suites 4, the plurality of automation cases 5 for each of the plurality of automation suites 4 is displayed in a list, wherein the order of the list of the plurality of automation cases 5 can be based on pre-determined factors or may be variable according to preferences of the user.

In the preferred embodiment of the present invention there are three different types of pages: a main page 6, an automation suite page 7, and an automation case page 8. The main page 6 displays the list of the plurality of automation suites 4, wherein the user can select a specific automation suite 40 from the plurality of automation suites 4 by clicking a hyperlink for the specific automation suite 40. When the user clicks on the hyperlink for the specific automation suite 40, the user is directed to the automation suite page 7 for the specific automation suite 40. The automation suite page 7 displays the list of the plurality of automation cases 5 for the specific automation suite 40, wherein the user can select a specific automation case 50 from the plurality of automation cases 5 by clicking a hyperlink for the specific automation case 50. When the user clicks on the hyperlink for the specific automation case 50, the user is directed to the automation case page 8 for the specific automation case 50. The automation case page 8 displays a list of logs for the specific automation case 50.

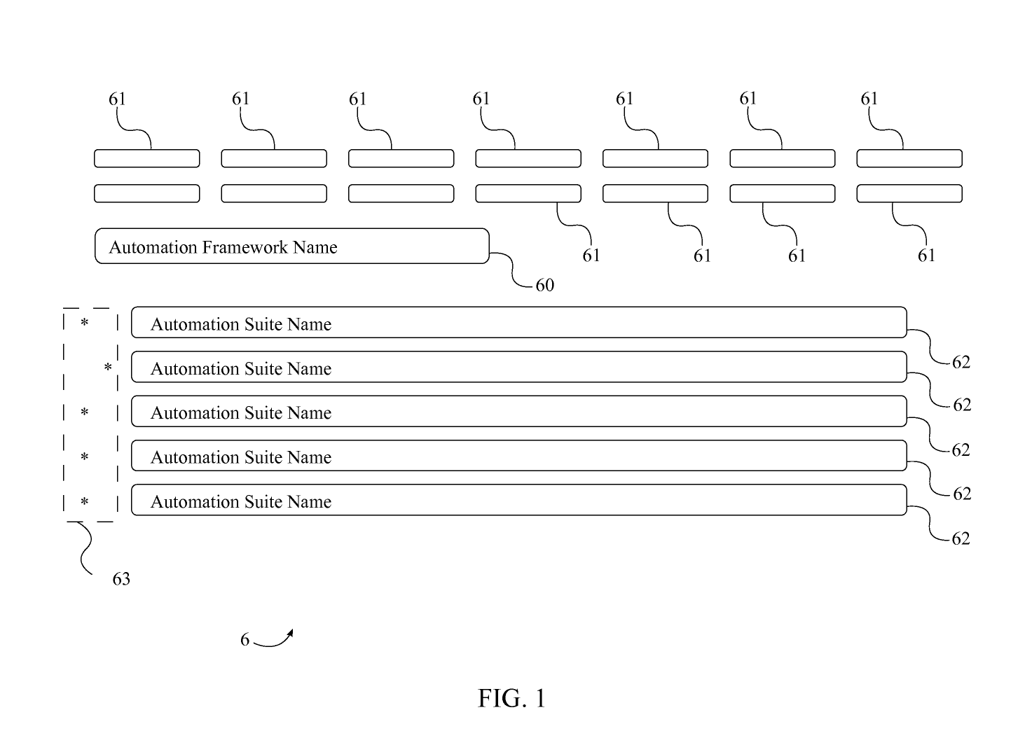

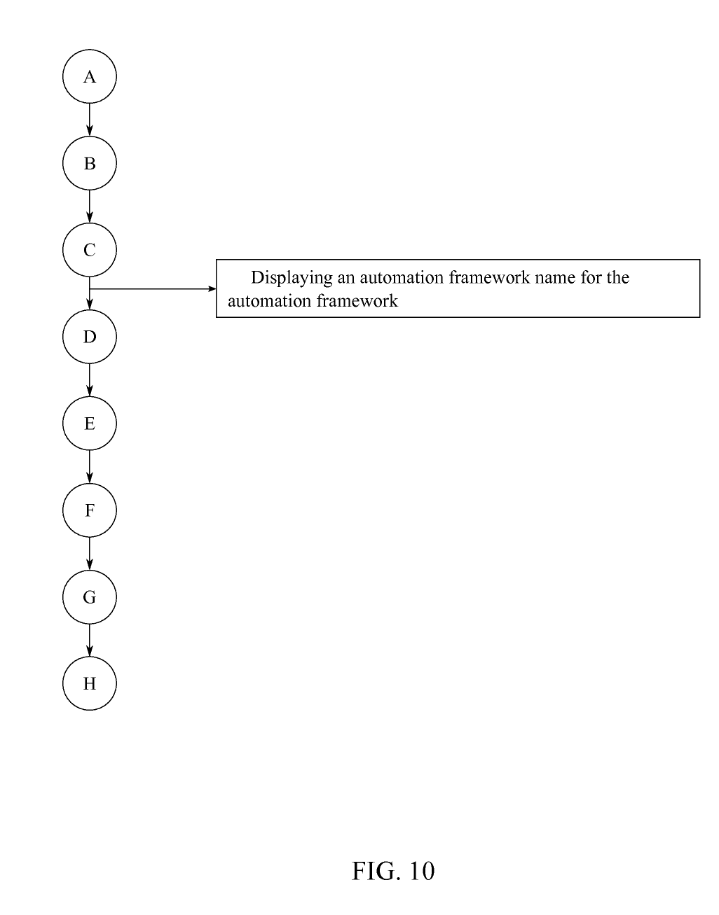

In reference to FIG. 1, the main page 6 comprises a framework title output 60, a plurality of command outputs 61, a plurality of suite title outputs 62, and an automation status output bar 63. The framework title output 60 shows the user the active automation framework, serving as a convenient means of affirming that the user is looking at the desired automation framework. In other words, the framework title output 60 displays an automation framework name for the automation framework 1 that is currently connected to the plurality of automation suites 4 through the software of the present invention, as stated in FIG. 10. This is beneficial in many environments where multiple networks may be set up, or where the software of the present invention is used for individual computers, as the user can ensure that the software is connected to the appropriate network.

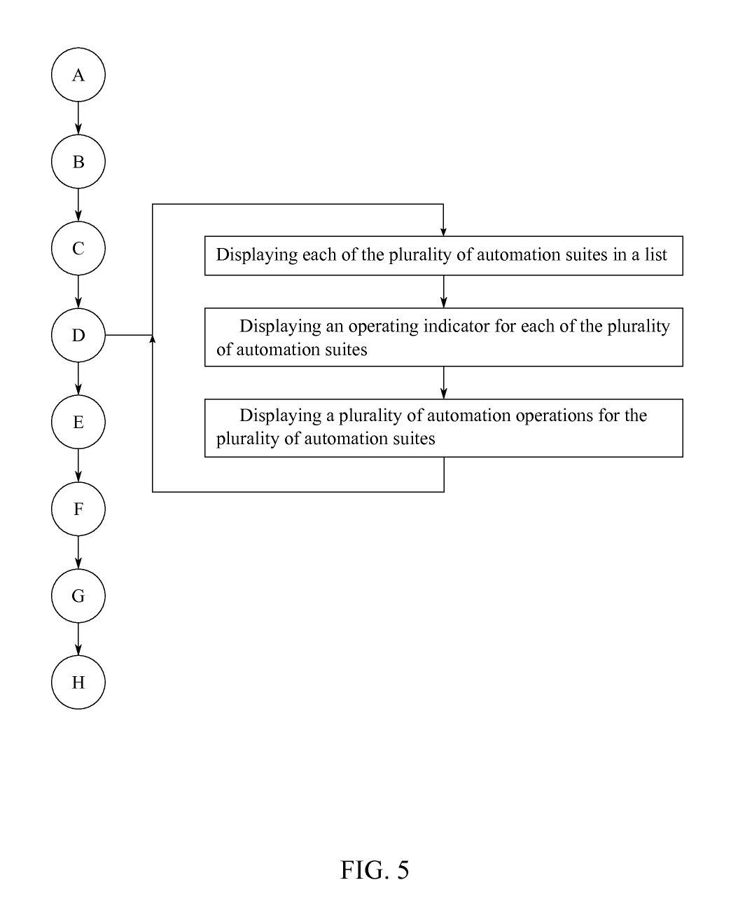

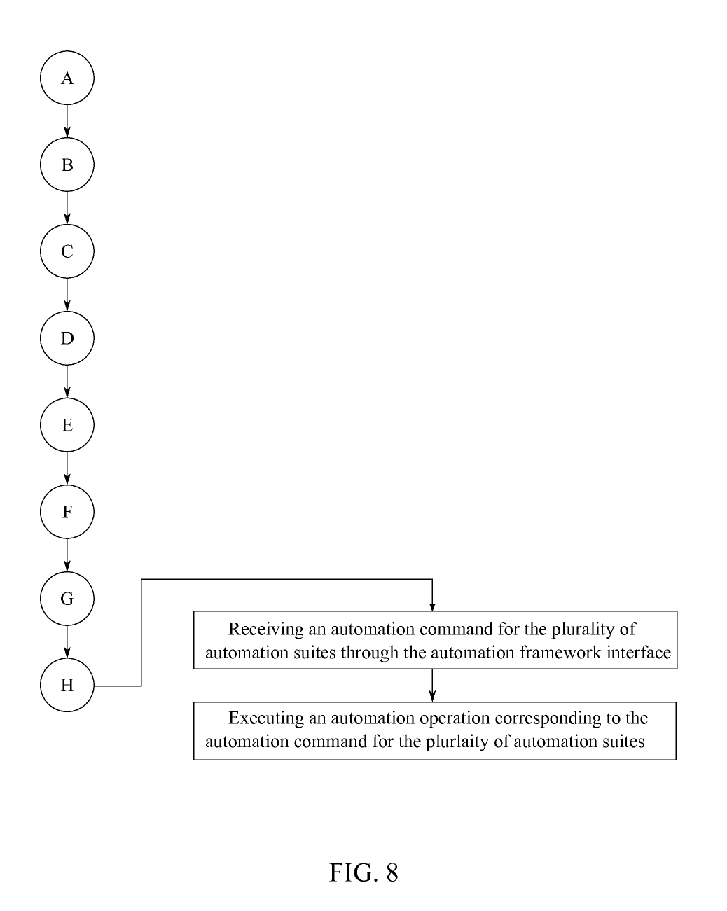

In reference to FIG. 1 and FIG. 5, the plurality of command outputs 61 displays inputs for a plurality of automation operations for the plurality of automation suites 4 that the user can enter to display specific information or perform a specific action. The plurality of command outputs 61 may be selectable as hyperlinks, may designate text commands that can be entered by the user, or may be any other form of command that can be entered through the automation framework interface 2. In reference to FIG. 8, when the user enters an automation command from the plurality of command outputs 61 for the plurality of automation suites 4, the software receives the automation command through the automation framework interface 2 and executes an automation operation corresponding to the automation command, wherein the automation operation is for the plurality of automation suites 4. For example, the user might wish to display a history of entered commands for the plurality of automation suites 4 (an example of displaying specific information) or to refresh the display of the list of the plurality of automation suites 4 on the main page 6 (an example of performing a specific action).

Other examples of the automation command used for the plurality of automation suites 4 include: a create command used to create a new test case in an automation suite, a find command used to find a desired automation suite, a generate command used to create a new automation suite, a list command used to list each of the plurality of automation suites 4, a search command used to search through the plurality of automation suites 4, and an execute command to execute an automation suite.

In reference to FIG. 1 and FIG. 5, the plurality of suite title outputs 62 informs the user about the plurality of automation suites 4 available to use on the automation framework 1. The plurality of suite title outputs 62 displays the list of the plurality of automation suites 4, wherein each of the plurality of automation suites 4 corresponds to a specific suite title output 70 from the plurality of suite title outputs 62. Each of the plurality of suite title outputs 62 provides a hyperlink that when selected, directs the user to the automation suite page 7 for the specific automation suite 40 corresponding to the specific suite title output 70. Clicking the hyperlink of the specific suite title output 70 functions as an automation suite selection, wherein the software receives the automation suite selection and displays the automation suite page 7 and the accompanying data for the specific automation suite 40.

In further reference to FIG. 1 and FIG. 5, the automation status output bar 63 comprises an operating indicator for each of the plurality of automation suites 4. The operating indicator for each of the plurality of automation suites 4 is positioned next to the respective suite title output 70 from the plurality of suite title outputs 62. The operating indicator depicts two states for each of the plurality of automation suites 4, wherein the operating indicator for each of the plurality of automation suites 4 depicts whether or not the automation suite is currently running. In the preferred embodiment, the operating indicator is an asterisk (*) symbol that is stationary to indicate that the automation suite is not running and is animated in a lateral motion along an imaginary horizontal line to indicate that the automation suite is running. However, it is also possible for other animations to be used in other embodiments of the present invention, or for two different stationary images to be used to depict the two states.

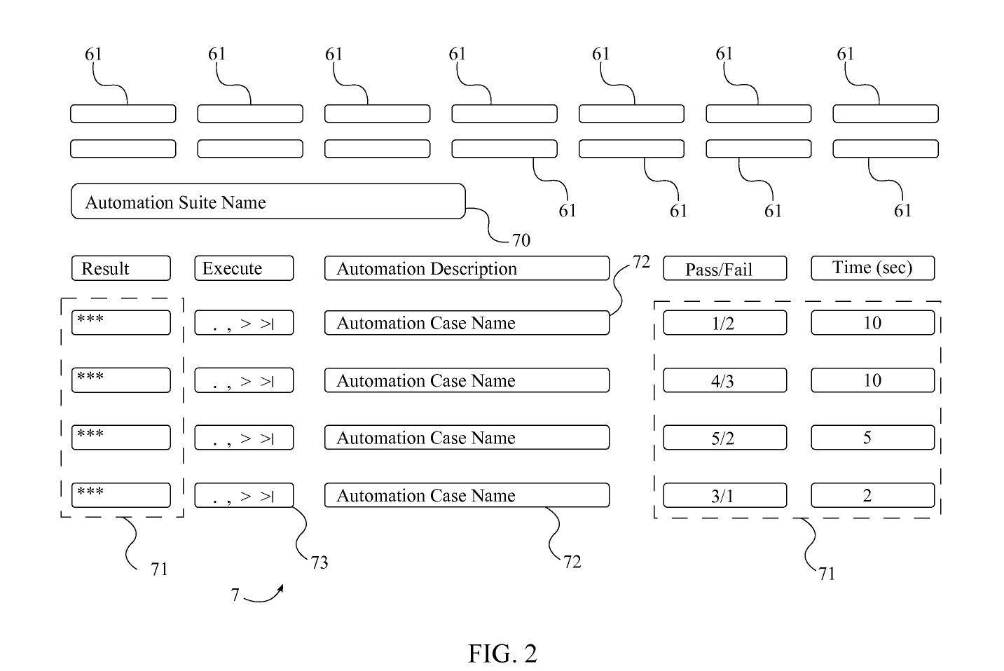

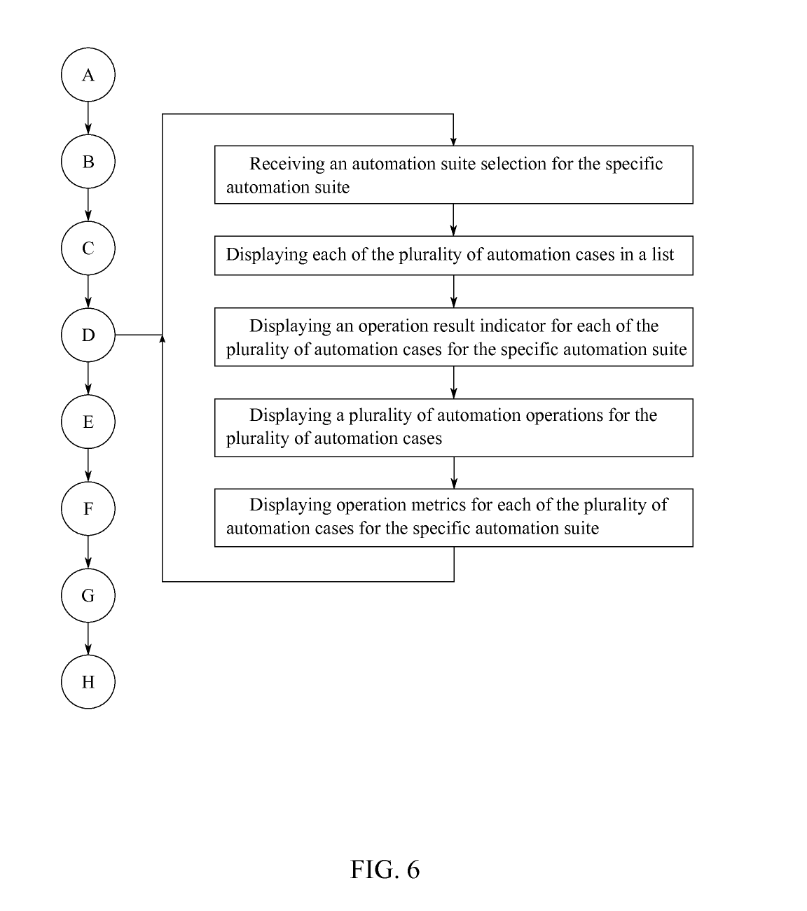

In reference to FIG. 2 and FIG. 6, when the automation suite selection is made for the specific automation suite 40, the software receives the automation suite selection through the automation framework interface 2 and the automation suite page 7 for the specific automation suite 40 is opened. The automation suite page 7 comprises a suite title output 70, a plurality of command outputs 61 for the plurality of automation cases 5, a plurality of test data columns 71, and a plurality of case title outputs 72. Additionally, the automation suite page 7 displays the list of the plurality of automation cases 5 for the specific automation suite 40. Similar to the framework title output 60, the suite title output 70 displays a convenient visual confirmation of the specific automation suite 40 that is being viewed by the user. Additionally, the suite title output 70 serves as a hyperlink that, when clicked, returns the user to the main page 6.

Each of the plurality of automation cases 5 has mandatory properties that define each of the plurality of automation cases 5. Examples of the mandatory properties include, but are not limited to, an automation name, automation descriptions, automation dependencies, automation prerequisites, automation preprocessors, automation expected results, automation post processors, and automation editable files. The mandatory properties are used to perform the various automaton operations. In addition to the mandatory properties, each of the plurality of automation cases 5 may also have optional properties that can be added, deleted, or edited. The optional properties are modified using the plurality of command outputs 61, wherein each modification to the optional properties is time stamped to track the action history.

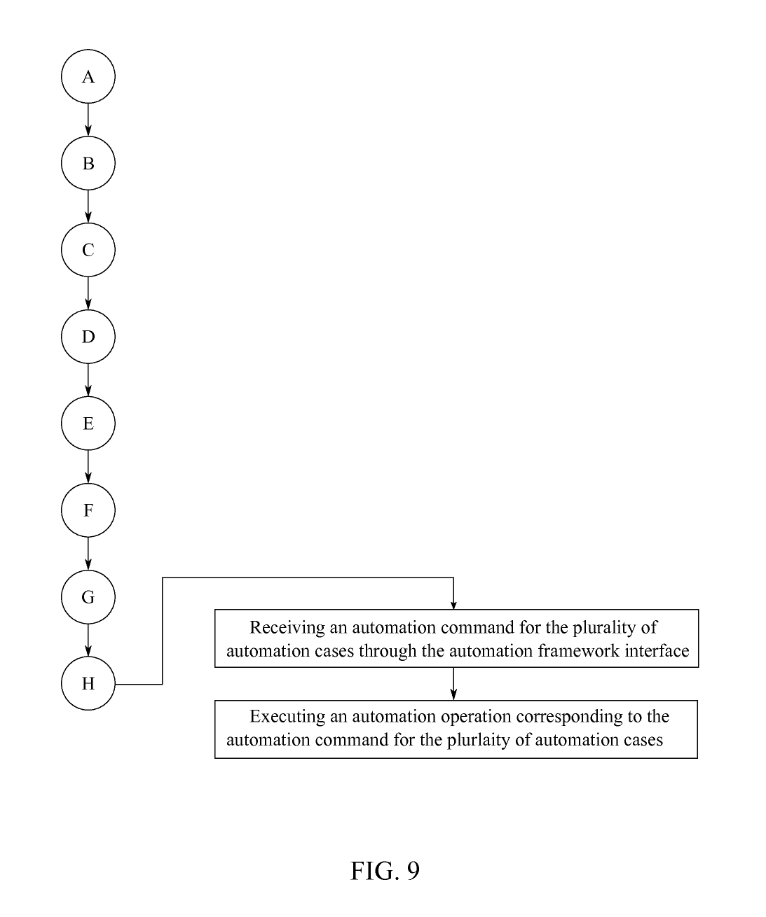

In reference to FIG. 2 and FIG. 6, the plurality of command outputs 61 displayed through the automation suite page 7 are equivalent to the plurality of command outputs 61 displayed through the main page 6 in terms of function. The only difference being that the plurality of command outputs 61 on the automation suite page 7 is for the plurality of automation cases 5, wherein the automation command from the plurality of command outputs 61 that is entered through the automation suite page 7 is executed for the plurality of automation cases 5 of the specific automation suite 40. In reference to FIG. 9, when the user enters the automation command from the plurality of command outputs 61 for the plurality of automation cases 5, the software receives the automation command through the automation framework interface 2 and executes the automation operation corresponding to the automation command, wherein the automation operation is for the plurality of automation cases 5. Examples of the automation command used for the plurality of automation cases 5 include: an add command used to create a automation case for the specific automation suite 40, a delete command used to remove a desired automation case, a modify command used to alter a desired automation case, and a search command used to search through the plurality of automation cases 5.

In further reference to FIG. 2 and FIG. 6, the plurality of case title outputs 72 informs the user about the plurality of automation case available to use for the specific automation suite 40. The plurality of case title outputs 72 displays the list of the plurality of automation cases 5, wherein each of the plurality of automation cases 5 corresponds to a specific case title output 80 from the plurality of case title outputs 72. Each of the plurality of case title outputs 72 provides a hyperlink that when selected, directs the user to the automation case page 8 for the specific automation case 50 corresponding to the specific case title output 80. Clicking the hyperlink of the specific case title output 80 functions as an automation case selection, wherein the software receives the automation case selection and displays the automation case page 8 and the accompanying data for the specific automation case 50.

In reference to FIG. 2 and FIG. 6, the plurality of test data columns 71 is displayed alongside the list of the plurality of automation cases 5 for the specific automation suite 40 and displays information for various parameters of the individual tests run by each of the plurality of automation cases 5. The plurality of test data includes an operation result indicator and operation metrics for each of the plurality of automation cases 5 for the specific automation suite 40. In the preferred embodiment of the present invention, the operation result indicator for each of the plurality of automation cases 5 is displayed to the left of the list of the plurality of automation cases 5, while the operation metrics for each of the plurality of automation cases 5 is displayed to the right of the list of the plurality of automation cases 5.

In reference to FIG. 2, the operation result indicator displays the test status for the most current test run of each of the plurality of automation cases 5. In the preferred embodiment of the present invention, the operation result indicator displays a color coded result pertaining to each test run. For example, the operation result indicator being green indicates a pass, the operation result indicator being red indicates a fail, the operation result indicator being black indicates the test run has not yet been complete, and the operation result indicator being blue indicates the test run is in progress. As an alternative to the color coded result, the operation result indicator could display a different symbol for each test status. When the user hovers the mouse pointer over the operation result indicator, a brief summary of the test run is displayed as a pop-up, indicating any notable information gathered from the test run

In further reference to FIG. 2, the operation metrics for each of the plurality of automation cases 5 includes a pass/fail score and a test duration. The pass/fail score is a cumulative ratio of the number of passes and the number of fails for each time the specific automation case 50 has been run. For example, if the specific automation case 50 is run ten times, passes six times and fails four times, then the pass/fail score for the specific automation case 50 would be displayed as 6/4, 1.5, etc. The test duration displays how long it took for the most current test run of the specific automation case 50 to be performed.

In reference to FIG. 2 and FIG. 6, the automation suite page 7 further comprises a plurality of execution commands 73 for each of the plurality of automation cases 5. In the preferred embodiment of the present invention, the plurality of execution commands 73 for each of the automation cases is displayed in between the operation result indicator for each of the automation cases and the list of the plurality of automation cases 5. Each of the plurality of execution commands 73 dictates how the specific automation case 50 is supposed to run. The user can select an automation command from the plurality of automation commands for depending on how the user desires to run the specific automation case 50.

In the preferred embodiment of the present invention, the automation command selected by the user can be one of four types: a stop execution command, a continuous execution command, a single execution command, and a sequential execution command. The stop execution command is used when the specific automation case 50 is already in progress and the user wishes to end the specific automation case 50 prematurely. The continuous execution command runs the specific automation case 50 continuously a pre-determined interval of time. The single execution command runs the specific automation case 50 once. The sequential execution command run the specific automation command and then proceeds to sequentially run each of the following automation cases in the list of the plurality of automation cases 5.

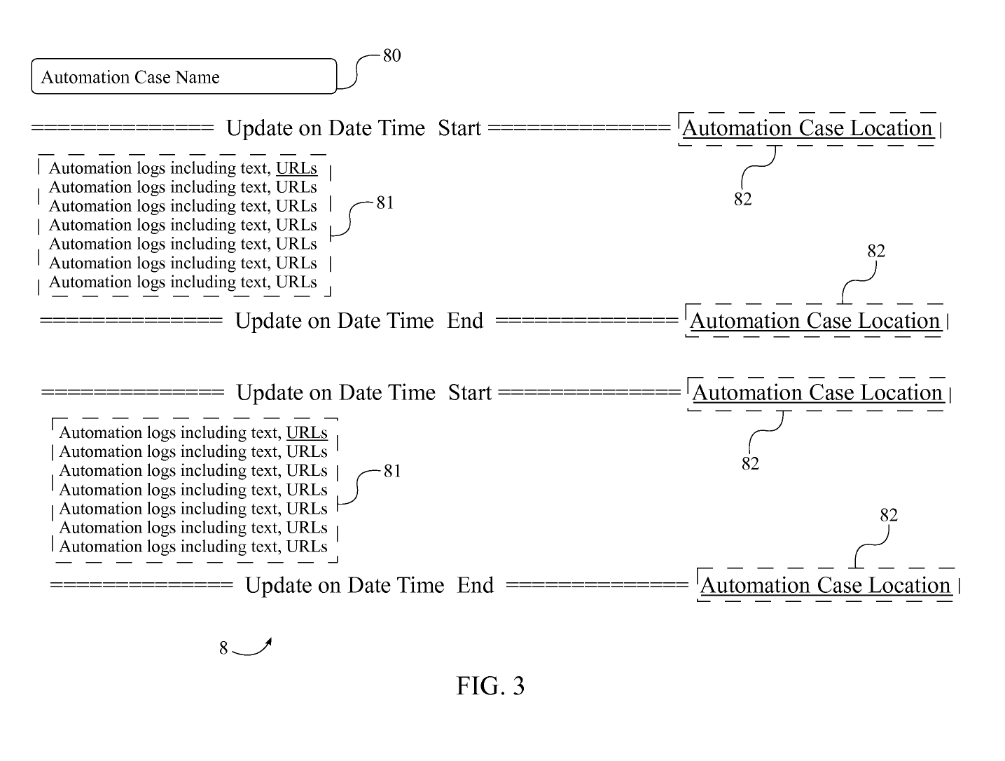

In reference to FIG. 3, when the automation case selection is made for the specific automation case 50, the software receives the automation case selection through the automation framework interface 2 and the automation case page 8 for the specific automation case 50 is opened. The automation case page 8 comprises a case title output 80, a log output column 81, and a case location output 82. Similar to the framework title output 60 and the suite title output 70, the case title output 80 displays a convenient visual confirmation of the specific automation case 50 that is being viewed by the user, and serves as a hyperlink that, when clicked, returns the user to the automation suite page 7 for the specific automation suite 40. The case location output 82 displays the specific automation suite 40 to which the specific automation case 50 belongs and also serves as a hyperlink to the automation suite page 7.

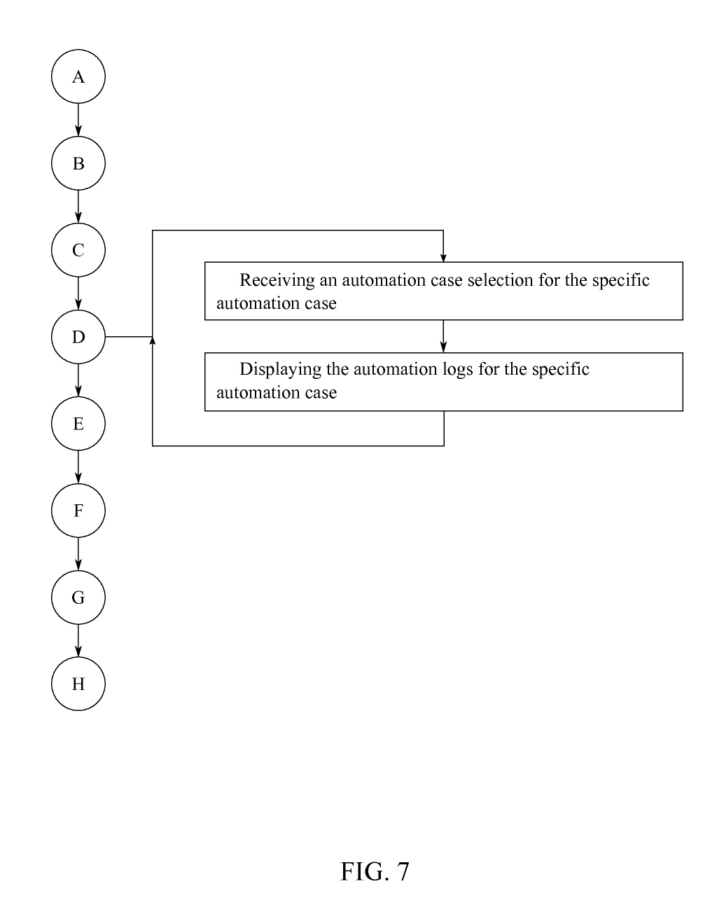

In reference to FIG. 3 and FIG. 7, the log output column 81 displays a list of automation logs for each test run of the specific automation case 50. The list of the automation logs for each test run is time stamped in order to differentiate and easily identify the automation logs for each test run. Each of the automation logs displays full text describing the event/test results and provides a uniform resource locator (URL) for accessing scripts for each event. The URL may be provided by as a hyperlink, or an additional hyperlink may be provided for accessing the scripts of each of the automation logs. Once the scripts are accessed, the user can modify the scripts for the next time the specific automation case 50 is run.

In other embodiments, the present invention may provide additional pages or alter the components of each individual page. Layouts of pages may also be altered if so desired.

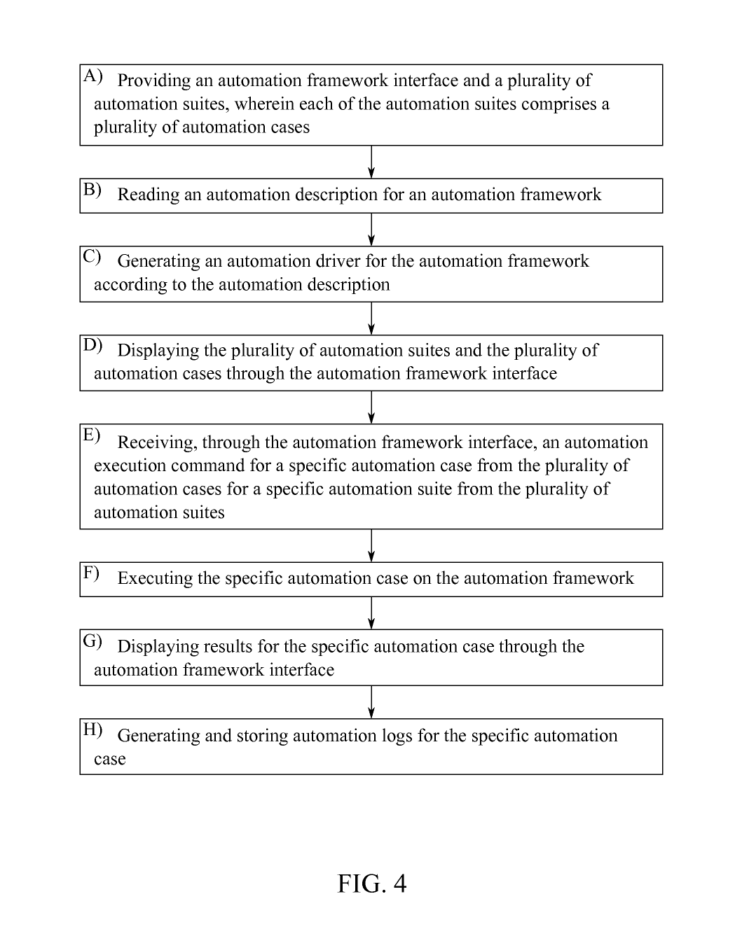

In order to manage and operate the plurality of automation suites 4 on the automation framework 1, the following method is carried out by the software supporting the automation framework interface 2. In reference to FIG. 4, once connected to automation framework 1, the software reads a an automation description for the automation framework 1, wherein the automation description provides details and parameters of the automation framework 1. By analyzing the automation description, the software then generates a automation driver 3 for the automation framework 1 according to the automation description. Once the automation driver 3 is created, the user can select the specific automation suite 40 or the specific automation case 50 to run on the automation framework 1.

In further reference to FIG. 4, through the display of the plurality of automation suites 4 on the main page 6, the user enters the automation suite selection for the specific automation suite 40. Upon receiving the automation suite selection, the software opens the automation suite page 7 for the specific automation suite 40 and displays the plurality of automation cases 5 for the specific automation case 50. The user then enters the automation command for the specific automation case 50 from the plurality of automation cases 5 through the automation suite page 7. Once the execution command is received by the software, the specific automation case 50 is executed on the automation framework 1 through the automation driver 3.

In yet further reference to FIG. 4, the results for the specific automation case 50 are then displayed through the automation framework interface 2. More specifically, the results are displayed through the automation suite page 7, wherein the operation result indicator and the operation metrics are used to display the results for the specific automation case 50. Additionally, the software generates and stores the automation logs for the test run of the specific automation case 50, wherein the user can view the automation logs through the automation case page 8 for the specific automation case 50.

Although the invention has been explained in relation to its preferred embodiment, it is to be understood that many other possible modifications and variations can be made without departing from the spirit and scope of the invention as hereinafter claimed.

What is claimed is:

1. A method for managing and operating automation software suites by executing computer-executable instructions stored on a non-transitory computer-readable medium, comprises the steps of:
providing an automation framework interface and a plurality of automation suites, wherein each of the automation suites comprises a plurality of automation cases;
reading an automation description for an automation framework;
generating an automation driver for the automation framework according to the automation description;
displaying the plurality of automation suites and the plurality of automation cases through the automation framework interface;
receiving, through the automation framework interface, an automation execution command for a specific automation case from the plurality of automation cases for a specific automation suite from the plurality of automation suites;
executing the specific automation case on the automation framework;
displaying results for the specific automation case through the automation framework interface; and
generating and storing automation logs for the specific automation case.

2. The method for managing and operating automation software suites by executing computer-executable instructions stored on a non-transitory computer-readable medium, the method as claimed in claim 1 further comprises the steps of:
displaying an operating indicator for each of the plurality of automation suites.

3. The method for managing and operating automation software suites by executing computer-executable instructions stored on a non-transitory computer-readable medium, the method as claimed in claim 1 further comprises the steps of:
receiving an automation suite selection for the specific automation suite; and
displaying an operation result indicator for each of the plurality of automation cases for the specific automation suite.

4. The method for managing and operating automation software suites by executing computer-executable instructions stored on a non-transitory computer-readable medium, the method as claimed in claim 1 further comprises the steps of:
receiving an automation suite selection for the specific automation suite; and
displaying operation metrics for each of the plurality of automation cases for the specific automation suite.

5. The method for managing and operating automation software suites by executing computer-executable instructions stored on a non-transitory computer-readable medium, the method as claimed in claim 1 further comprises the steps of:
receiving an automation case selection for the specific automation case; and
displaying the automation logs for the specific automation case.

6. The method for managing and operating automation software suites by executing computer-executable instructions stored on a non-transitory computer-readable medium, the method as claimed in claim 1 further comprises the steps of:
displaying each of the plurality of automation suites in a list.

7. The method for managing and operating automation software suites by executing computer-executable instructions stored on a non-transitory computer-readable medium, the method as claimed in claim 6, wherein each of the plurality of automation suites is displayed as a hypertext link.

8. The method for managing and operating automation software suites by executing computer-executable instructions stored on a non-transitory computer-readable medium, the method as claimed in claim 1 further comprises the steps of:
displaying each of the plurality of automation cases in a list.

9. The method for managing and operating automation software suites by executing computer-executable instructions stored on a non-transitory computer-readable medium, the method as claimed in claim 8, wherein each of the plurality of automation cases is displayed as a hypertext link.

10. The method for managing and operating automation software suites by executing computer-executable instructions stored on a non-transitory computer-readable medium, the method as claimed in claim 1 further comprises the steps of:
displaying an automation framework name for the automation framework.

11. The method for managing and operating automation software suites by executing computer-executable instructions stored on a non-transitory computer-readable medium, the method as claimed in claim 1 further comprises the steps of:
displaying a plurality of automation operations for the plurality of automation suites.

12. The method for managing and operating automation software suites by executing computer-executable instructions stored on a non-transitory computer-readable medium, the method as claimed in claim 1 further comprises the steps of:
displaying a plurality of automation operations for the plurality of automation cases.

13. The method for managing and operating automation software suites by executing computer-executable instructions stored on a non-transitory computer-readable medium, the method as claimed in claim 1 comprises:
displaying a plurality of execution commands for each of the plurality of automation cases.

14. The method for managing and operating automation software suites by executing computer-executable instructions stored on a non-transitory computer-readable medium, the method as claimed in claim 1, wherein the automation command is a stop execution command.

15. The method for managing and operating automation software suites by executing computer-executable instructions stored on a non-transitory computer-readable medium, the method as claimed in claim 1, wherein the automation command is a continuous execution command.

16. The method for managing and operating automation software suites by executing computer-executable instructions stored on a non-transitory computer-readable medium, the method as claimed in claim 1, wherein the automation command is a single execution command.

17. The method for managing and operating automation software suites by executing computer-executable instructions stored on a non-transitory computer-readable medium, the method as claimed in claim 1, wherein the automation command is a sequential execution command.

18. The method for managing and operating automation software suites by executing computer-executable instructions stored on a non-transitory computer-readable medium, the method as claimed in claim 1 further comprises the steps of:
receiving an automation command through the automation framework interface; and
executing an automation operation corresponding to the automation command.

19. The method for managing and operating automation software suites by executing computer-executable instructions stored on a non-transitory computer-readable medium, the method as claimed in claim 18 further comprises the steps of:
receiving the automation command for the plurality of automation suites; and
executing the automation operation for the plurality of automation suites.

20. The method for managing and operating automation software suites by executing computer-executable instructions stored on a non-transitory computer-readable medium, the method as claimed in claim 18 further comprises the steps of:
receiving the automation command for the plurality of automation cases; and
executing the automation operation for the plurality of automation cases.
